(19) United States
(12) Patent Application Publication
(10) Pub. No.: US 2005/0000878 A1
(43) Pub. Date: Jan. 6, 2005

(54) Filtering apparatus of water dispenser

(76) Inventor: Chang Kuei Tang, Banchiau City (TW)

Correspondence Address: Yi-Wen Tseng, 509 ROOSEVELT BLVD. #D306, FALLS CHURCH, VA, 22044, US

(21) Appl. No.: 10/611,913

(22) Filed: Jul. 3, 2003

(51) Int. Cl. B01D 24/00

(52) U.S. Cl. 210/287; 210/436

(57) ABSTRACT

A filtering apparatus of a water dispenser, installed at a water inlet port of the water dispenser is disclosed. The filtering apparatus has a shell. A recessed slot is formed on a top portion of the shell. The recessed slot has a water inlet aperture at a bottom surface thereof, allowing a mouth of a water bottle to be inserted therein. The bottom surface of the shell further comprises a water outlet aperture. Filtering material is installed in the shell. A one-way valve is installed on a top portion of the shell, such that air can flow into the shell via the one-way valve, while water is blocked from flowing out of the shell through the one-way valve. Thereby, by inversely inserting the water bottle into the shell of the filtering apparatus, water is filtered before flowing into the water dispenser.

### BACKGROUND OF THE INVENTION

The present invention relates generally to a filtering apparatus of a water dispenser and, more particularly, to a filtering apparatus filtering water contained in a water bottle before flowing into the water dispenser.

The conventional water dispenser typically includes a filter mechanism installed on a bottled type water storage device. The water storage device is inversely disposed on/in the water dispenser, allowing water contained therein to flow into the water dispenser. For example, in U.S. Pat. No. 6,354,344, the filter mechanism includes a housing containing a water filter with a throat removably connected to the bottled water container; a plurality of vent holes located in an upper surface of the filter housing and sized to permit air from the filter to escape into the water container and allow continuous water flow from the container into the filter; a monitoring and disabling mechanism having a shutoff apparatus moveable between first and second locations, the first location being one in which water dispensing is monitored by the mechanism, and the second location being one in which the mechanism is placed in an interfering position with the connection between the housing and the water container; wherein the shutoff apparatus automatically moves into the second location after the predetermined amount of water usage has occurred, and without interrupting water dispensing from the then-connected water container, so that the used filter shutoff device must be replaced in order to reestablish connection to a successive water container.

In the above-mentioned conventional filter mechanism, to avoid water overflowing through the vent holes, the monitoring and disabling mechanism is formed. Such monitoring and disabling mechanism is normally complex to cause inconvenience in fabrication, assembly and application.

### BRIEF SUMMARY OF THE INVENTION

The present invention provides a filtering apparatus of water dispenser. The filtering apparatus has a simple structure and can be easily fabricated, assembled and used.

The filter apparatus is installed on a water inlet of a water dispenser. The filter apparatus includes a shell. The shell has a slot recessed from a top portion thereof, a water inlet aperture formed on a bottom surface of the slot allowing the mouth of a water bottle to be inserted therein, and a filtering material in the shell. A one-way valve is installed on the top portion of the shell, such that when the water bottle is inversely inserted into the shell of the filter apparatus, water contained in the water bottle is filtered thereby prior to flowing into the water dispenser.

The one-way valve is installed on the air inlet port of the top portion of the shell, such that when the water contained in the water bottle flows into the shell, the water push the one-way valve upwardly to block the air inlet port. Water contained in the shell cannot overflows from the air inlet port thereof. When water is consumed to cause a drop of the water level, the one-way valve is relieved from the air inlet port due to gravitation thereof. Air can thus enter through the air inlet port to improve the water flow.

The present invention is characterized in that the filter apparatus can be directly or detachably attached to the mouth of the water bottle. For example, hooks can be formed on the mouth of the water bottle and engaged within the slot of the shell. Alternatively, screws can be used to thread the filter apparatus on the mouth of the water bottle.

The present invention is further characterized in that the shell of the filter apparatus is constructed by a bottom seat and a top lid integrated together by high frequency thermal fusion, such that the shell cannot be dissembled. Alternatively, screws can be used to fasten the bottom seat and the top lid together, such that the shell can be dissembled allowing the filtering material to be changed.

### BRIEF DESCRIPTION OF THE DRAWINGS

These, as well as other features of the present invention, will become more apparent upon reference to the drawings wherein:

FIG. 1 shows an exploded view of a filter apparatus provided by the present invention;

FIG. 2 shows a perspective view of the filter apparatus;

FIG. 3 shows a cross sectional view of the filter apparatus;

FIG. 4 shows a cross sectional view of another embodiment of filter apparatus;

FIG. 5 shows the shell with full water level; and

FIG. 6 shows the shell with air entering therein.

### DETAILED DESCRIPTION OF THE INVENTION

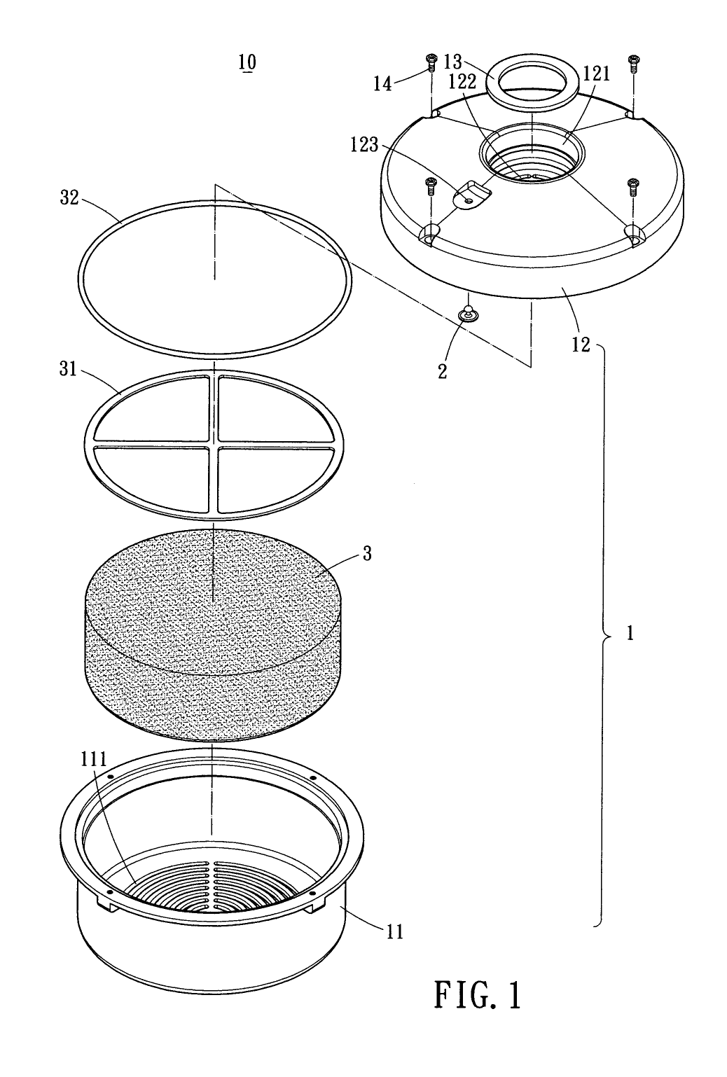

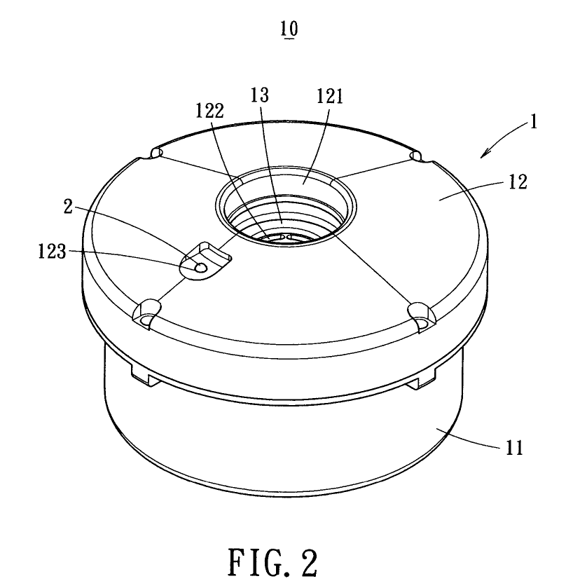

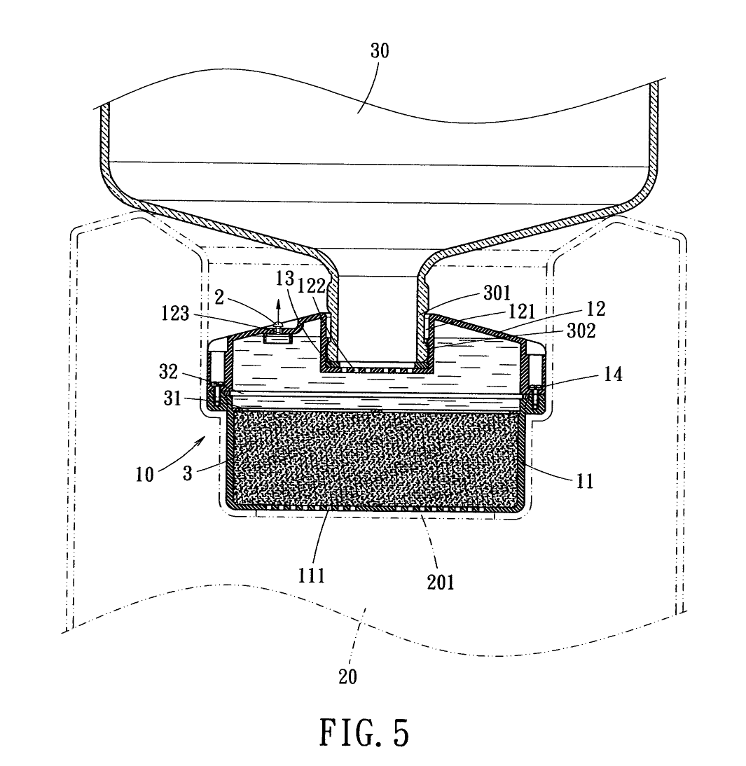

Referring to FIGS. 1 and 2, a filter apparatus 10 can be installed on water inlet port 201 of a water dispenser 20 or directly installed on a mouth 301 of a water bottle 30. In this embodiment, the filter apparatus 10 is installed on the mouth 301 of the water bottle 30 (as shown in FIG. 5). The filter apparatus 10 includes a shell 1 assembled by a bottom seat 11 and a top lid 12. A plurality of outlet ports 111 are formed on the bottom seat 11 allowing filtered water flowing from the shell 1 to the water inlet port 201 of the water dispenser 20.

The top lid 12 is mounted on the bottom seat 11. The top lid 12 includes a slot 121 recessed from a top center thereof. A plurality of water inlet apertures 122 are formed on a bottom surface of the slot 121, allowing water flowing to the bottom seat 11 therethrough after the mouth 301 of the water bottle 30 is inserted in the slot 121. A sealing pad 13 is disposed in the slot 121 to achieve a sealing effect.

As shown in FIGS. 1 and 2, an air inlet port 123 is formed on a top portion of the top lid 12. A one-way valve 2 is installed on the air inlet port 123. When the shell 1 has a full water level, the one-way valve 2 is pushed upward to block the air inlet port 123. When the shell has a lower water level, the air inlet port 123 is open and air can flow into the shell 1 therethrough. In addition, a filtering material 3 is installed in the shell 1, and a partitioning board 31 and a sealing pad 32 are disposed on the filtering material 3.

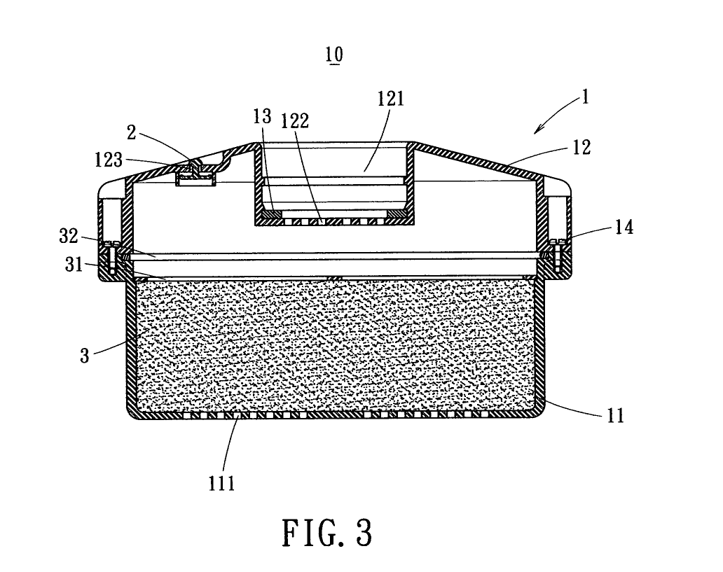

Referring to FIG. 3, while assembling the shell 1, the filtering material 3, the partitioning board 31 and the sealing pad 32 are disposed on the bottom seat 11. The lid 12 is then attached to the bottom seat 11 using a screw member 14, such that the lid 12 is detachable fastened to the bottom seat 11 for the convenience of charging filtering material 3. The bottom seat 11 and the top lid 12 can also be permanently attached to each other by high frequency wave thermal fusion to be undetachable from each other. The one-way valve 2 is the installed at the air inlet port 123 of the top lid, and a sealing pad 13 is installed in the slot 121 to complete the assembly of the filter apparatus 10.

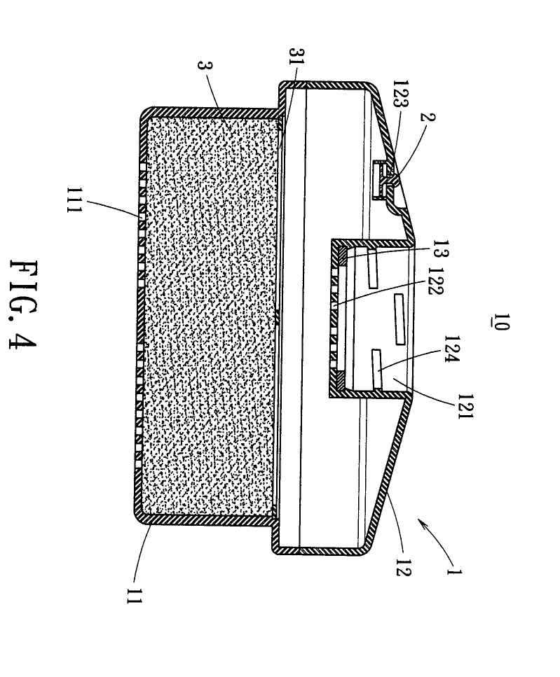

The assembled filter apparatus 10 is then detachably attached to the mouth 301 of the water bottle 30. In this embodiment, hooks or barbs 302 are formed on the mouth 301 of the water bottle 30 (as shown in FIG. 5). By inserting the barbs 302 in the slot 121 of the shell 1, the filter apparatus 10 is attached to the mouth 301 of the water bottle 30. As shown in FIG. 4, other attaching method can also be used. For example, threads 124 can be formed on an inner edge of the slot 121 of the filter apparatus 121, and the filter apparatus 10 can be threaded in the mouth 301 of the water bottle 30.

Referring to FIG. 5, a water bottle 30 filled with water is inversely installed in the water dispenser 20. Water is then flowing from the water bottle 30 into the shell 1 through the water inlet apertures 122 at the bottom surface of the slot 121. Water is thus filtered by the filtering material 3 in the shell 1. Once the shell 1 is full of water, the one-way valve 2 is pushed upward to block the air inlet port 123 of the top lid 12 to prevent water from overflowing therefrom. Meanwhile, air cannot flow into the shell through the air inlet port 123 either.

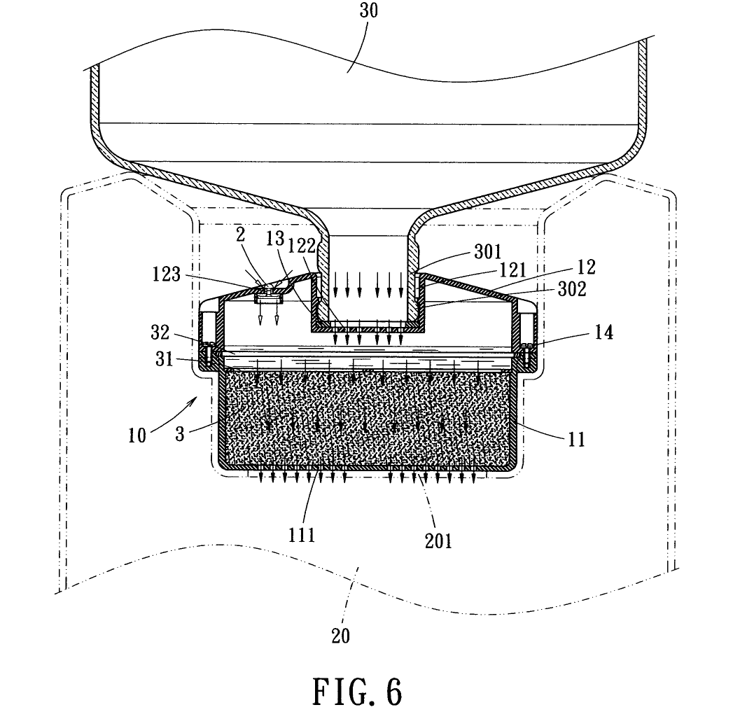

As shown in FIG. 6, when the user switches on the tap of the water dispenser 20, water level in the shell 1 lowers, such that the one-way valve 2 is relieved from the air inlet port 123 by gravitation. Therefore, external air can instantly flow into the shell and result in a more fluent water dispense process.

In this embodiment, only one air inlet port 123 and one one-way valve 2 are installed to prevent overflow of the water in the shell and control air inlet. Therefore, the fabrication, assembly and application are simple and convenient.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A filter apparatus of a water dispenser, comprising:
a shell, comprising a plurality of water outlet apertures formed on a bottom surface thereof allowing water flowing from the shell to an water inlet port of the water dispenser, a slot recessed from a bottom portion thereof allowing a mouth of a water bottled to be inserted therein, and a plurality of water inlet apertures formed on a bottom surface of the slot, allowing water flowing from the water bottle into the shell, the shell further comprising an air inlet port at the top portion thereof;
a filtering material disposed in the shell, allowing water to be filtered before flowing into the water dispenser; and
a one-way valve mounted at the air inlet port of the shell;
wherein when the shell has a full water level, the one-way valve is pushed to block the air inlet valve, and when the water level of the shell is lowered, the one-way valve is relieved from the air inlet valve allowing air flowing therethrough.

2. The filter apparatus of claim 1, wherein the filter apparatus is installed at a water inlet port of the water dispenser.

3. The filter apparatus of claim 1, wherein the filter apparatus is directly mounted to the mouth of the water bottle.

4. The filter apparatus of claim 1, wherein the shell includes a top lid and a bottom seat attached to each other.

5. The filter apparatus of claim 1, wherein the top lid is detachably fastened to the bottom seat by a screw member.

6. The filter apparatus of claim 1, wherein the top lid is fixed on the bottom seat via high frequency thermal fusion.

7. The filter apparatus of claim 1, wherein the shell includes threads formed on an interior edge of the slot allowing the filter apparatus to be threaded in the mouth of the water bottle.

8. The filter apparatus of claim 1, further comprising sealing pads in the slot and on the filtering material.

9. The filter apparatus of claim 1, wherein the mouth of the water bottle comprises hooks for engaging the mouth with the slot of the shell.
